(19) United States
(12) Patent Application Publication
(10) Pub. No.: US 2025/0252711 A1
(43) Pub. Date: Aug. 7, 2025

(54) MULTI-DIMENSIONAL ATTENTION FOR DYNAMIC CONVOLUTIONAL KERNEL

(71) Applicant: INTEL CORPORATION, Santa Clara, CA (US)

(72) Inventors: Dongqi Cai, Beijing (CN); Anbang Yao, Beijing (CN); Chao Li, Beijing (CN); Liang Cheng, Shanghai (CN); Yurong Chen, Beijing (CN)

(21) Appl. No.: 18/856,123

(22) PCT Filed: May 16, 2022
(86) PCT No.: PCT/CN2022/093032

§ 371 Date: Oct. 11, 2024

(51) Int. Cl. G06V 10/77; G06V 10/52; G06V 10/72; G06V 10/778; G06V 10/82

(52) U.S. Cl. CPC G06V 10/7715; G06V 10/72; G06V 10/82; G06V 10/52; G06V 10/778

(57) ABSTRACT

A convolutional layer of a computer model generates a dynamic convolutional filter based on the input feature map of the convolutional layer. The convolutional layer includes an attention model that generates a set of attention weights to dynamically adjust the convolutional filter applied by the model based on the input to the convolutional layer. The attention weights are generated with respect to multiple dimensions, which may include spatial position, input channel, output channel, and a respective combination of a set of static convolutional filters. The weights be generated with respect to each of the static convolutional filters, such that the different types (i.e., dimensions) of the weights may be applied element-wise to the respective convolutional filters and the filters, after application of the weights, may then be combined to generate the dynamic convolutional filter.

### CROSS REFERENCE TO PRIOR APPLICATION

This application is a national stage application under 35 U.S.C. § 371 of International Application No. PCT/CN2022/093032, filed May 16, 2022, entitled “MUTLI-DIMENSIONAL ATTENTION FOR DYNAMIC CONVOLUTIONALS KERNAL,” which is incorporated herein by reference in its entirety.

### TECHNICAL FIELD

This disclosure relates generally to computer modeling with convolutional layers, and particularly to a model with a convolutional layer with a dynamic convolutional kernel based on an input to the convolutional layer.

### BACKGROUND

Convolutional layers in computer models may be used in many types of image processing to extract features and characterize information about an image. Such models may be used for many types of computer vision, such as object detection (e.g., identifying the bounding boxes and classification of objects), image segmentation, object tracking, environment perception, and so forth. For many of these models, convolution is a common and fundamental operation. In typical implementations, the convolutional kernel applied to an input feature map is determined during training and is static during application. However, this inflexibility may neglect to benefit from information within the input data that may signal the relative position of important information within the input data that may be better characterized by different convolutional kernels. While various approaches have been used to improve specific types of models, these typically modify model structure, how inputs are represented or encoded, and so forth.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example, and not by way of limitation, in the figures of the accompanying drawings.

FIGS. 1A-1B illustrate a convolutional filter used in a convolutional layer of various neural networks.

FIG. 2 shows an architecture for generating a dynamic convolutional filter, according to one embodiment.

FIGS. 3 & 4 illustrate attention weights and application of the weights for generating a dynamic convolutional filter, according to one embodiment.

FIG. 5 shows an example of components of an attention model for generating attention weight sets, according to one embodiment.

FIG. 6 shows one example of the attention model with layers for implementing the attention model, according to various embodiments.

FIG. 7 provides an example structure of an object detector that may include components using convolutional layers that may use a dynamic convolutional filter, according to various embodiments.

FIGS. 8A-8B shows a visual comparison of object detection results using a dynamic convolutional filter according to one embodiment.

FIG. 9 shows example computer model inference and computer model training.

FIG. 10 illustrates an example neural network architecture.

FIG. 11 is a block diagram of an example computing device that may include one or more components used for training, analyzing, or implementing a computer model in accordance with any of the embodiments disclosed herein.

### DETAILED DESCRIPTION

### Overview

The systems, methods, and devices of this disclosure each have several innovative aspects, no single one of which is solely responsible for all desirable attributes disclosed herein. Details of one or more implementations of the subject matter described in this specification are set forth in the description below and the accompanying drawings.

This disclosure provides a convolutional layer that determines a dynamic convolutional filter based on an input feature map and applies the dynamic convolutional filter as the convolutional layer. The convolutional layer with the dynamic convolutional kernel may be used in place of a static convolutional filter in many types of applications, including object detection and other image processing approaches. In object detection, for example, this convolutional layer design can be plugged into any component of an object detector having convolutional layers (e.g., the model's backbone, head, or neck) to significantly boost the detection performance with negligible extra computational cost. Unlike current solutions of convolutional layer designs, this approach may be used to implement a dynamic convolutional filter for convolutional operations at each layer, providing improved object detection accuracy. Similarly, the dynamic convolutional layer discussed herein may be used to perform convolutions in any other suitable type of model.

Specifically, at each convolutional layer, the input feature vector is used to determine attention weights along several dimensions of the convolutional filter space. Particularly, the attention weights may denote values across spatial size, input channels, output channels, and with respect to each of several convolutional filters (e.g., to weight a combination of the convolutional filters). These types of attention weights are complementary to each other and provide different means for modifying the resulting dynamic convolutional filter across the various dimensions. As such, the multiple directions in which the attention weights may affect the convolutional filter may be referred to as “omni-directional.” In one embodiment, a set of static convolutional filters are combined to generate the dynamic convolutional filter based on the respective attention weights for each filter. The respective attention weights along each dimension are generated and applied to generate the dynamic convolutional filter. As one means for applying the attention weights, the attention weights may be applied with element-wise multiplication operations and subsequent linear summarization to obtain the dynamic convolutional filter. This approach may significantly strengthen the feature-abstracting ability of fundamental convolutional operations of a detector in a unified way. As a “drop-in” replacement for static convolutional operations, the dynamic convolutional filter may be used as a replacement in many types of models. Additional examples are discussed below showing example benefits in object detection models. As such, this approach may also be applied to different object detection solutions and many downstream tasks such as instance segmentation, object tracking, and image captioning. Finally, the use of the “omni-directional” attention permits dynamically learning and applying attention weights scalars in a filter/kernel-adaptive, sample-adaptive, channel-wise, or spatial-aware way.

For purposes of explanation, specific numbers, materials and configurations are set forth in order to provide a thorough understanding of the illustrative implementations. However, it will be apparent to one skilled in the art that the present disclosure may be practiced without the specific details or/and that the present disclosure may be practiced with only some of the described aspects. In other instances, well known features are omitted or simplified in order not to obscure the illustrative implementations.

In the following detailed description, reference is made to the accompanying drawings that form a part hereof, and in which is shown, by way of illustration, embodiments that may be practiced. It is to be understood that other embodiments may be utilized and structural or logical changes may be made without departing from the scope of the present disclosure. Therefore, the following detailed description is not to be taken in a limiting sense.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order from the described embodiment. Various additional operations may be performed, and/or described operations may be omitted in additional embodiments.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B, and C). The term “between,” when used with reference to measurement ranges, is inclusive of the ends of the measurement ranges. The meaning of “a,” “an,” and “the” include plural references. The meaning of “in” includes “in” and “on.”

The description uses the phrases “in an embodiment” or “in embodiments,” which may each refer to one or more of the same or different embodiments. Furthermore, the terms “comprising,” “including,” “having,” and the like, as used with respect to embodiments of the present disclosure, are synonymous. The disclosure may use perspective-based descriptions such as “above,” “below,” “top,” “bottom,” and “side”; such descriptions are used to facilitate the discussion and are not intended to restrict the application of disclosed embodiments. The accompanying drawings are not necessarily drawn to scale. The terms “substantially,” “close,” “approximately,” “near,” and “about,” generally refer to being within +/−20% of a target value. Unless otherwise specified, the use of the ordinal adjectives “first,” “second,” and “third,” etc., to describe a common object, merely indicate that different instances of like objects are being referred to, and are not intended to imply that the objects so described must be in a given sequence, either temporally, spatially, in ranking or in any other manner.

In the following detailed description, various aspects of the illustrative implementations will be described using terms commonly employed by those skilled in the art to convey the substance of their work to others skilled in the art.

### Dynamic Convolutional Kernel

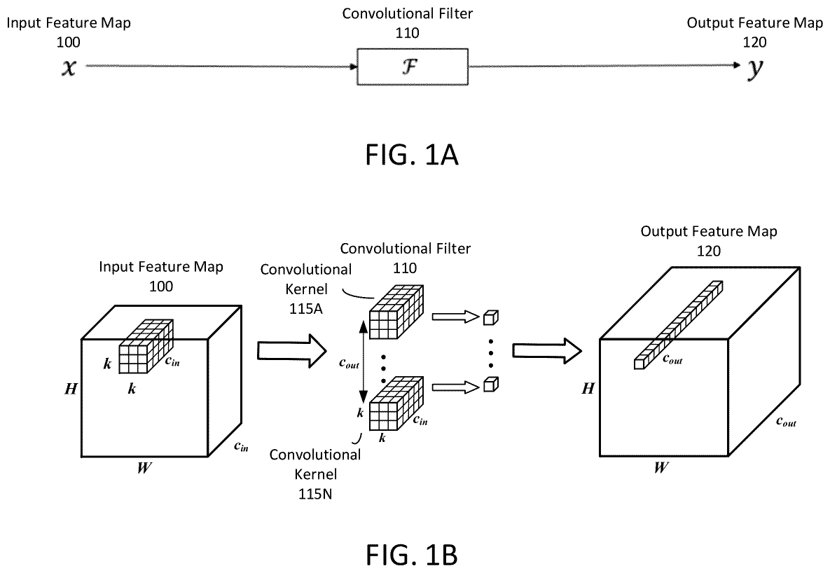

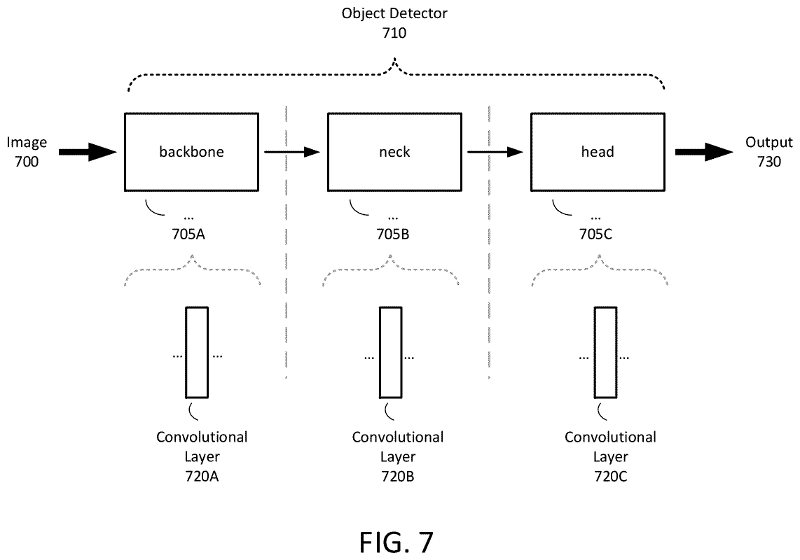

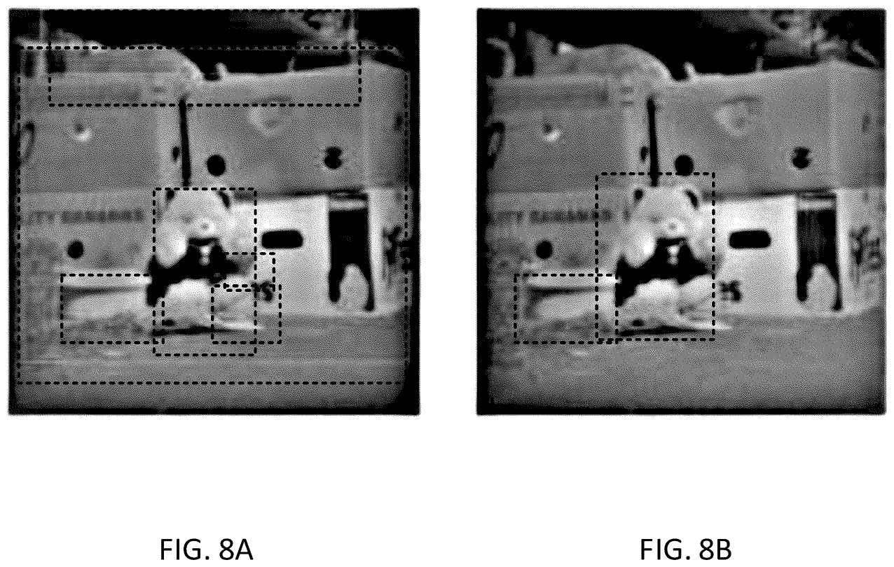

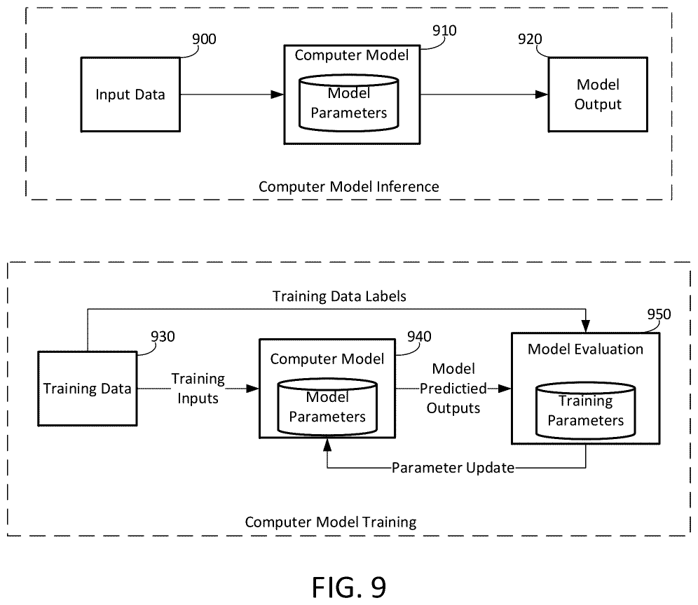

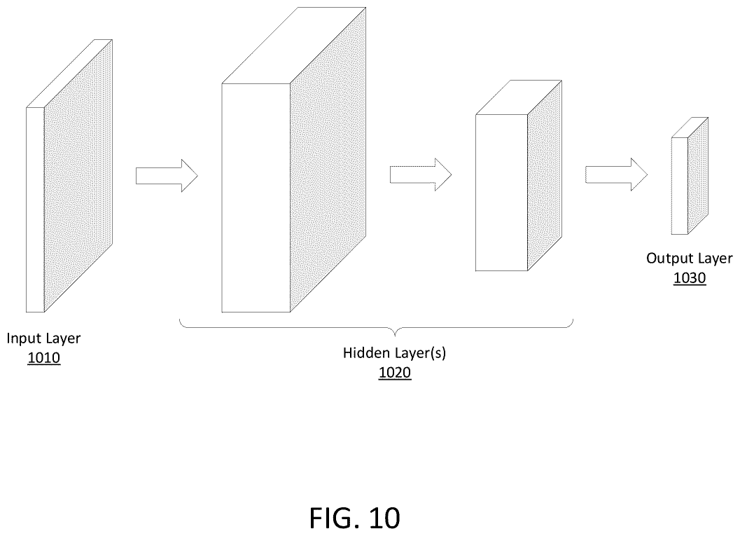

FIGS. 1A-B illustrate a convolutional filter used in a convolutional layer of various neural networks. A convolutional layer is a common and fundamental operation of many types of networks, including components of deep object detection models, which is discussed below in a more detailed example. In general, the convolutional operation plays a key role in modeling contextual cues for object detection by processing an input feature map 100 to an output feature map 120 through application of a convolutional filter 110. To perform the convolution, weights of the convolutional filter 110 are applied to a sliding window of the input feature map 100 to generate the output feature map 120. As discussed below with respect to FIGS. 9-10, computer models typically include parameters that are used to process inputs to predict outputs. Such computer models may be iteratively trained to learn parameters, including weights, for predicting various types of outputs based on input data. As discussed further in FIG. 10, individual layers in a neural network may receive input activations and process the input activations to generate output activations of the layer. Embodiments of convolutional layers, including with a dynamic convolutional filter, may be included in many types of computer models such as the example object detection models discussed with respect to FIGS. 7-8.

FIG. 1B shows additional details of the convolutional filter 110 as applied to an input portion of the input feature map 100 to generate a corresponding portion of the output feature map 120. The input feature map 100 has a number of spatial dimensions, each of which include a number of input channels cᵢₙ. In the example of FIG. 1B, the input feature map has two spatial dimensions corresponding to a height H and width W of the input feature map. The spatial dimensions may correspond to spatial information or regions processed by the corresponding computer model, for example, to analyze a received camera image having a resolution (e.g., a number of color channels), although the input feature maps 100 with other spatial dimensions may also be used (e.g., for a volumetric region having three dimensions (height, width, and depth). The convolutional filter 110 may be applied to a k×k (e.g., 1×1, 3×3, 5×5, etc.) portion of spatial dimensions of the input feature map 100 to generate a portion of the output feature map 120 having a number of output channels cₒᵤₜ. To process the entire input feature map 100 and generate the entire output feature map 120, a sliding window is moved across the input feature map 100 to select portions of the input feature map 100, apply the convolutional filter 110, and generate the corresponding portions for the output feature map 120. In the example shown in FIG. 1B, the input feature map 100 and output feature map 120 have the same height H and W, which may be generated by applying the convolutional filter 110 centered at each spatial position in the input feature map 100. In other embodiments, the output feature map 120 may have a different size than the input feature map 100, for example by modifying which particular k×k portions of the input feature map 100 are selected by the sliding window.

The convolutional filter 110 includes a set of individual convolutional kernels 115A-N that each have weights for a k×k portion of the input feature map 100 and a number of input channels cᵢₙ. The number of convolutional kernels 115 corresponds to the number of output channels cₒᵤₜ in the output feature map 120. Each convolutional kernel 115 may include weights for the k×k portion of input from the input feature map 100 and corresponding input channels cᵢₙ. As such, each convolutional kernel 115 in the convolutional filter 110 may include k×k×cᵢₙ individual weights for a convolutional operation that generates a corresponding value of an output channel of the output feature map 120. Including the set of cₒᵤₜ convolutional kernels 115, the convolutional filter 110 may thus include a set of weights for k×k×cᵢₙ×cₒᵤₜ individual weights, as each spatial location, each input channel, and each output channel (e.g., corresponding to each convolutional kernel) may have separately defined weights. The outputs of the convolutional kernels 115A-N may then be concatenated to generate the output channels cₒᵤₜ for the portion of the output feature map 120 corresponding to the portion of the input feature map 100. As such, as used herein, a convolutional kernel 115 refers to the weights for a convolutional operation with a portion of the input feature map 100 to determine a value for one output channel in the output feature map 120, while the convolutional filter 110 refers to the set of convolutional kernels 115A-N that generate values for the corresponding set of output channels cₒᵤₜ in the output feature map 120 for the portion of the input feature map 100.

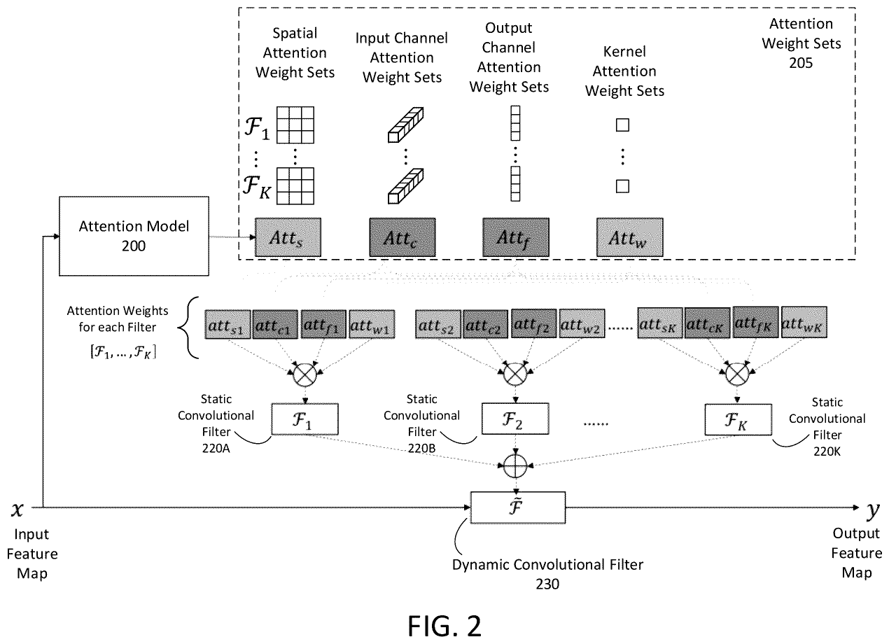

FIG. 2 shows an architecture for generating a dynamic convolutional filter 230, according to one embodiment. The dynamic convolutional filter 230 is designated [symbol] and is determined based on a combination of static convolutional filters 220A-K, designated [symbol] ₁, . . . , [symbol] _{K}. Similar to the convolutional filter 110 shown in FIG. 1B, each of the static convolutional filters 220A-K includes a set of convolutional kernels describing weights for generating a respective output channel. To determine the dynamic convolutional filter 230, the static convolutional filters 220 are modified by a set of attention weights and then combined to determine the dynamic convolutional filter 230.

The set of weights applied by the convolutional operation (e.g., the weights of dynamic convolutional kernel 230) is thus dynamic and a function of the input feature map input to the convolutional layer. To determine weights of the dynamic convolutional kernel 230 to be applied in the convolutional operation for the convolutional layer (e.g., as discussed in FIGS. 1A-B), the input feature map is input to an attention model 200 that determines, based on the input feature map, attention weights (as attention weight sets 205) for determining weights of the dynamic convolutional filter 230 (i.e., weights for the respective output filters [symbol] ₁, . . . , [symbol] _{K}). The attention model 200 determines the attention weight sets based on the particular distribution of features in the input feature map. That is, the way in which a particular data sample (i.e., an input feature map) distributes its values (e.g., which channels of this input feature map contain more or less information) may be used to determine a set of attention weight sets 205 for determining the dynamic convolutional filter 230. The attention weight sets 205 describe respective attention weights across multiple dimensions, which may include spatial locations, input channels, output channels, and a set of convolutional kernels. The attention weight sets 205 thus may include a set of spatial attention weights Attₛ describing weights for a plurality of spatial positions, a set of input channel attention weights Att_{c} describing attention weights for a plurality of input channels, a set of kernel attention weights Att_{f} describing respective weights for each static convolutional filter 220, and a set of output channel attention weights Att_{w} describing attention weights for a plurality of output channels. Each type of these attention weights may differ for each static convolutional filter 220, such that each static convolutional filter 220 may be varied across respective dimensions for combination in the dynamic convolutional filter 230. As such, each respective attention weight type may have an attention weight set for the respective static convolutional filters 220A-K, designated here by the respective subscripts. For example, the first static convolutional filter 220A may be modified by attₛ₁, att_{c1}, att_{f1}, and att_{w1}, while the final static convolutional filter 220K is modified by att_{sK}, att_{cK}, att_{fK}, and att_{wK}. In some embodiments, a single static convolutional filter 220 may be used, in which case there may not be kernel attention weights.

The following table highlights example characteristics of the various types of attention weights that may be used for generating the dynamic convolutional kernel 230.

TABLE 1

| | | Weight Parameters for per |
|---|---|---|
| Weight Type | Abbreviation | static convolutional Filter Fₙ: |
| Spatial Attention | Attₛ | attₛₙ ∈ [symbol] _{1×1×s} |
| Weights | | |
| Input Channel | Att_{c} | att_{cn} ∈ [symbol] _{1×cin×1} |
| Attention Weights | | |
| Output Channel | Att_{f} | att_{fn} ∈ [symbol] _{cout×1×1} |
| Attention Weight | | |
| Sets | | |
| Kernel Attention | Att_{w} | att_{wn} ∈ [symbol] |
| Weight Sets | | |

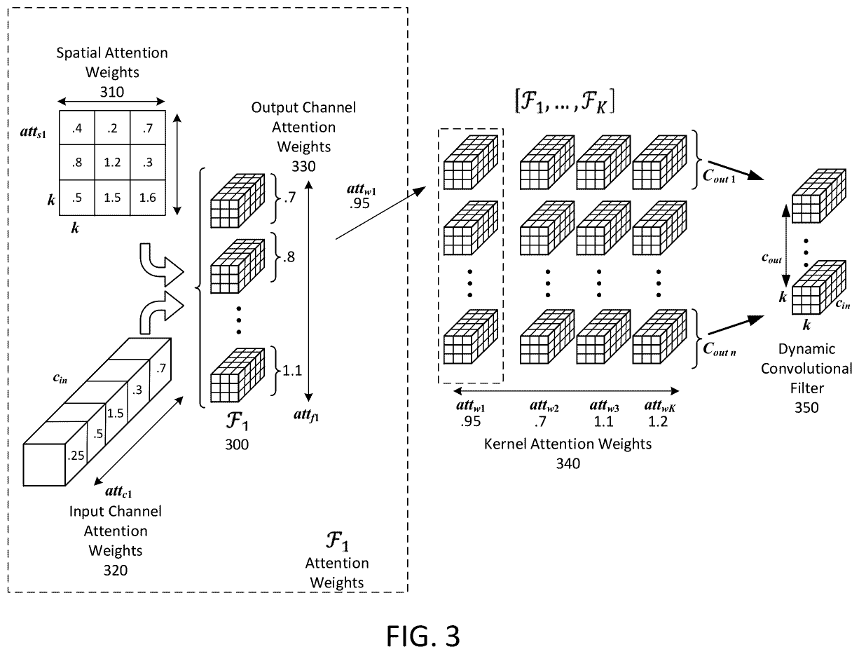

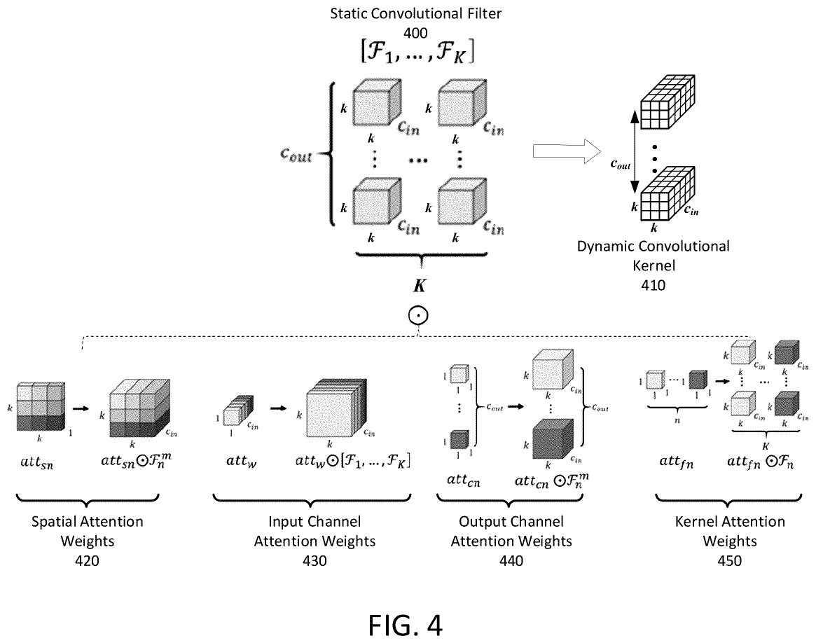

FIGS. 3 & 4 illustrate attention weights and application of the weights for generating a dynamic convolutional filter 350, according to one embodiment. Each type of attention weights may provide a respective set of values for modifying each convolutional filter across the respective dimensions, which may include spatial location, input channel, output channel, and as a respective filter for combination with others to generate the dynamic convolutional filter 350 (e.g., by combining the respective convolutional kernels). As such, each weight type of each weight set may include a weight for each possible position of the respective dimensions of the static convolutional filter as shown in the Table 1. FIG. 3 shows an example application of the respective attention weights to an example static convolutional filter 300 for a first static convolutional filter [symbol] 1. As shown in FIG. 3, and discussed above, the convolutional filter 300 [symbol] ₁ includes a set of convolutional kernels, each corresponding to an output channels cₒᵤₜ (e.g., 1-n).

As shown in Table 1, the spatial attention weights 310 for the static convolutional filter 300 include a set of s (k×k) individual weights for the spatial positions of the convolutional kernel. For example, the k×k (shown here as 3×3) spatial region processed by the kernels is described by s attention weights (here, 9 attention weights) in the attₛ₁ spatial attention weights 310 that corresponds to the first static convolutional filter [symbol] 1. Each of the spatial attention weights 310 is applied to the respective positions of each of the static convolutional kernels and input channels of the static convolutional filter 300. As such the spatial attention weights 310 may modify attention weights similarly across the spatial dimension across the different input channels and the different output channels for the filter.

Similarly, the respective input channel attention weights 320 (att_{c1}) includes a number of weights corresponding to the number of input channels cᵢₙ. As with the spatial attention weights 310, the input channel attention weights 320 are applied to the respective input channels across the kernels of the static convolutional filter 300. The input channel attention weights 320 may thus modify the weights with respect to the input channel across spatial positions and convolutional kernels (e.g., output channels).

The output channel attention weights 330 may designate particular attention weights for modifying entire individual convolutional kernels (each corresponding to an output channel of the filter) of the static convolutional filter 300. The output attention weights thus provide a set of weights for modifying relative contribution of the individual kernels (i.e., for output channels of the final dynamic) without affecting the contribution of the respective individual convolutional filter as a whole. The contribution of the static convolutional filter as a whole may be specified by the kernel attention weights 340, describing the respective contribution of kernels from that filter when combined to the individual kernels of the dynamic convolutional filter 350. As such, after the application of the attention weights for each static convolutional filter, the attention-modified kernels may be combined to generate the dynamic convolutional filter 350. In one embodiment, each of the attention weights may be applied multiplicatively and according to the respective attention weight dimensions for each static convolutional filter and then summed to yield the dynamic convolutional filter 350. The dynamic convolutional filter 350 in this embodiment may be formally described as:

$$= ( {n}_{} ⊙ {att}_{s n} ⊙ {att}_{c n} ⊙ {att}_{fn} ⊙ {att}_{w n} ) \qquad Equation 1$$

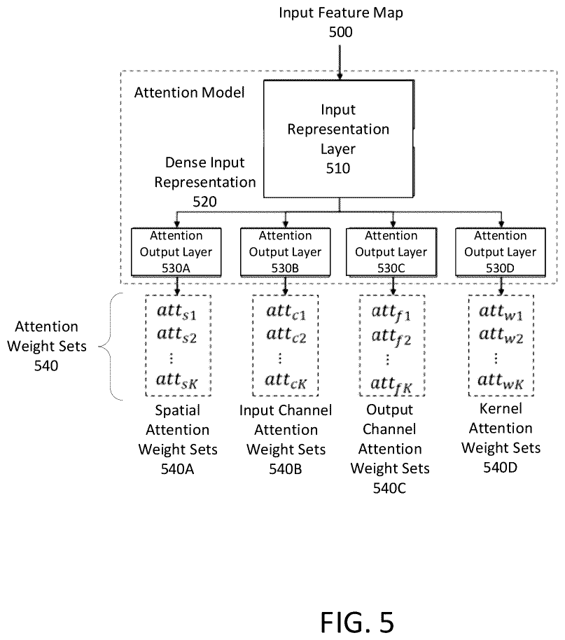

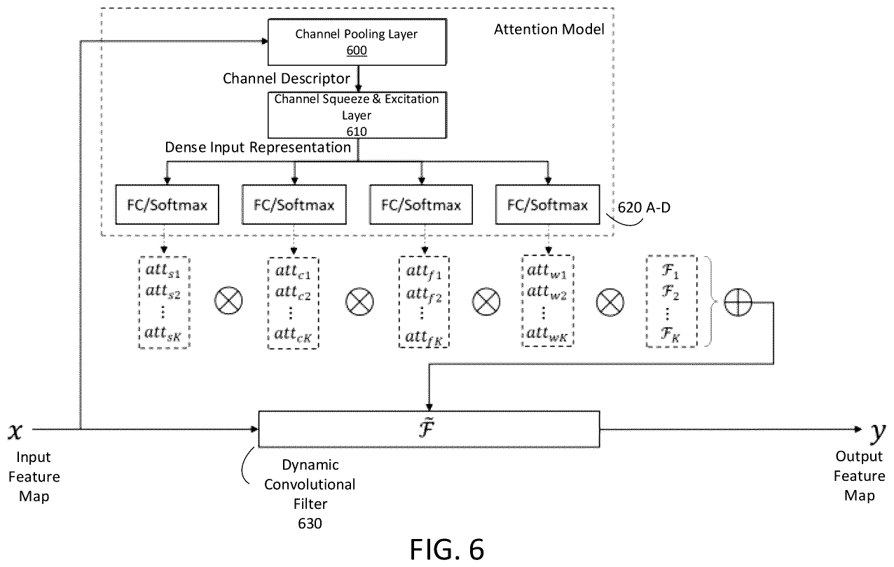

In Equation 1, [symbol] is the dynamic convolutional kernel, [symbol] ₙ is a static convolutional kernel of the [symbol] 1-K static convolutional kernels, and ⊙ is an element-wise multiplication (e.g., of the respective attention dimensions). As such, the overall convolutional operation for the convolutional layer may be defined as:

$$= 𝒳 * = 𝒳 * ( {n}_{} ⊙ {att}_{s n} ⊙ {att}_{c n} ⊙ {att}_{fn} ⊙ {att}_{w n} ) \qquad Equation 2$$

In which [symbol] is the output feature map, [symbol] is the input feature map, [symbol] is the dynamic convolutional filter, and the set of attention weights att are a function of the input feature map [symbol] as further discussed in FIGS. 5-6.

As another way to represent the effect of applying the attention weights across spatial position, input channel, output channel, and convolutional filter, consider a weight w having a position that may be described with respect to [symbol] ₙ, S, cᵢₙ, and cₒᵤₜ in the set of weights of a static convolutional filter [symbol] n describing s×cᵢₙ×cₒᵤₜ. To determine the attention-modified weight w′, the respective weights for the position of w with respect to each of the attention weight dimensions is applied:

$${w}^{′} ( {n}_{} , s , {c}_{i n} , {c}_{o u t} ) = w \times att \times att \times att \times \qquad Equation 3$$

FIG. 4 shows an example application of the respective attention weights, according to one embodiment. The illustration of FIG. 4 shows the respective dimensions for attention weights with example shading. As with the equations above, “⊙” represents an element-wise multiplication across dimensions of the respective static convolutional filter. As shown in the example of FIG. 4, the static convolutional filters 400 may include K static convolutional filters that may include a number of convolutional kernels corresponding to cₒᵤₜ layers. After applying the attention weights, the dynamic convolutional kernel 410 may be generated by combining (e.g., summing) the weights from the respective convolutional kernels.

To apply the attention weights, the static convolutional layers 400 may be multiplied element-wise by the respective attention weights. FIG. 4 shows the application of the respective attentional weights to the respective portions of the static convolutional filters 400. The spatial attention weights 420 may be defined by k×k(s) weights with a depth of 1 that is applied to positions of s in each convolutional kernel of the filter. Similarly, the input channel attention weights 430 may apply weights att_{w} as a 1×1×cᵢₙ set of weights to the corresponding k×k×cᵢₙ convolutional kernels. The output channel attention weights 440 provide weights for modifying entire convolutional kernels of the filter by affecting the k×k×cᵢₙ set of weights for a given convolutional kernel. Finally, the kernel attention weights 450 represent the respective contribution of the individual static convolutional filters and may provide an attention weight to affect the entire respective filter [symbol] ₙ, such that each single value of the 1×1×K kernel attention weights 450 affects the contribution of the entire static convolutional filter [symbol] n. By applying the various dimensions of attention weights in an element-wise way, several dimensions of attention weights can be applied to affect the dynamic convolutional kernel 410 and adaptively combine the static convolutional filters 400 using attention scalars across many dimensions. Relative to the computation of applying the convolutional kernel to the input feature map, the additional calculation in determining dynamic convolutional kernel 410 may be relatively small, as further discussed below.

In addition, while the weights are shown here as applicable to (and associated with) individual static convolutional filters 220, alternate embodiments of the various types of weights may be applied in a different manner, for example according to different individual convolutional kernels or by applying the same set of a type of attention weights to more than one static convolutional filter 220 (e.g., applying the same set of spatial attention weights or input channel attention weights to multiple static convolutional filters 220).

FIG. 5 shows an example of components of an attention model for generating attention weight sets 540, according to one embodiment. The attention model shown in FIGS. 5 & 6 are examples of attention models that may be used for the attention model 200 shown in FIG. 2. In this example, the input feature map 500 is processed by an input representation layer 510 to generate a dense input representation 520 of the input features. The particular data of the dense input representation 520 may vary in different embodiments and may include fewer channels and a compressed spatial area relative to the input feature map 500. In one embodiment, the dense input representation 520 has fewer spatial positions and fewer channels than the input feature map 500, such that the channels are compressed by the input representation layer 510 and relevant channel and spatial information is generated. In one embodiment, the W×H spatial positions of the input feature map 500 are compressed to a one-dimensional array of channel information, such that the dense input representation 520 represents the relative position of activations across the channels of the input feature map 500. As another benefit, this may permit the input representation layer 510 to receive input feature maps 500 of different sizes, such that the relevant channel information may be pooled across a variable width and height of input feature maps. As such, the input representation layer 510 may include a feature aggregation layer that compresses the dimensionality of the input feature map 500, and one or more excitation/activation layers to convert to the dense input representation 520. In this example, the attention model uses the input representation layer 510 to generate a joint representation that is then used by a set of attention output layers 530A-D to generate respective attention weight sets 540 for spatial attention weights 540A, input channel attention weights 540B, output channel attention weights 540C, and kernel attention weights 540D. While shown in this figure as generating weights for each Static Convolutional Filter 220A-K, in other embodiments the various attention weights for different dimensions may be represented differently.

Each of the respective attention dimensions may yield different dimensions of the resulting weight sets from the attention output layers 530. For example, the kernel attention weights describe one value for each of the K convolutional filters, such that the kernel attention weight sets are described as a 1×K array. Likewise, the spatial attention weight sets attₛ 540A may generate s weights for each of the K filters, yielding s x K spatial attention weights; the input channel attention weight sets att_{c} 540B may generate cᵢₙ weights for each of the K filters, yielding cᵢₙ×K input channel attention weights; and the output channel attention weight sets attₛ 540C may generate cₒᵤₜ weights for each of the K filters, yielding cₒᵤₜ×K output channel attention weights.

The attention output layers 530A-D may generate the respective types of attention weights 540A-D with various types of processing layers. In general, the dense input representation may be interpreted by one layer and scaled to the dimensions of the respective types of attention weights. The layers of the attention model (e.g., in the input representation layer 510 and attention output layers 530A-D) may thus include various parameters that may be learned during training of the convolutional layer. The learned parameters may be used to generate an effective dense input representation 520 from the input feature map 500 and translate the dense input representation 520 to each of the respective attention weights 540A-D.

FIG. 6 shows one example of the attention model with layers for implementing the attention model, according to various embodiments. Similar to prior examples, the convolutional layer of FIG. 6 provides for the generation of a dynamic convolutional filter 630 that is used for a convolutional operation to convert an input feature map to an output feature map. The attention model receives the input feature map to generate multi-dimensional attention weights across several dimensions that may be used to dynamically modify and combine the convolutional filters [symbol] ₁- [symbol] _{K} for the dynamic convolutional filter 630.

In this example, the attention model includes a channel pooling layer 600 that receives the input feature map to generate a channel descriptor. The channel pooling layer 600 pools the values across the spatial dimensions of the input feature map to obtain representative values in the channel descriptor. In this example, the channel pooling layer 600 may perform global average pooling or global maximum pooling to determine a value for each channel of the input feature map that is representative of that channel for the feature map as a whole. This may reduce the dimensionality of the input feature map from H×W×cᵢₙ to 1×1×cᵢₙ in the channel descriptor. Next, to obtain the dense input representation, an additional layer reduces the number of channels to the dense input representation through a channel squeeze and excitation layer 610.

The channel squeeze and excitation layer 610 receives the channel descriptor and generates the dense input representation describing the relative portions of interest across the channels. In one embodiment, the channel squeeze and excitation layer 610 is implemented with a fully-connected layer, such as a multi-layer-perceptron (MLP), followed by a batch normalization layer (BN) and an activation layer, such as a rectified linear unit (ReLU) layer. To apply the dense input representation and generate respective attention weights, in this example attention output layers 620A-D include a fully connected layer (e.g., MLP) and a SoftMax layer to scale (via the connected layer) and smooth (via SoftMax) the dense input representation to the respective size of the corresponding attention weight types. As such, the attention model may be considered to compress/encode the input feature value to the dense input representation, which is then expanded/decoded to the respective sizes of the attention weights by the attention output layers 620A-D. In this example, the dense input representation may be jointly determined for each of the attention output layers; in other embodiments the input feature map may be differently processed with more or fewer joint layers between the different types of attention weight output dimensions.

As also discussed above, the respective weights [symbol] (e.g., attₛₙ, att_{cn}, att_{fn}, and att_{wn}) for each convolutional filter [symbol] ₁- [symbol] _{K} across the various dimensions may be multiplicatively applied to one another and the respective filter [symbol] ₙ and then summed for each convolutional kernel to generate the respective convolutional kernels for the dynamic convolutional filter 630. This is more formally given by Equation 1 as discussed above. As such, the various attention weights provide for scalars along multiple dimensions for modifying the filter(s) to be combined for the dynamic convolutional filter 630.

The various types of attention weights across the multiple dimensions permits the attention mechanism to more precisely modify the convolutional operation of the layer with dynamic convolutional filter 630 according to different characteristics of the input feature map. The convolutional layer with dynamic convolutional filters may be used with many types of computer models, particularly those that process images or video (e.g., as a sequence of images or as individual images). As the attention model may be included within the layer, parameters for the attention model of the dynamic convolutional filter 630 may be learned with respect to the particular convolutional layer of the model and may be “dropped in” for prior convolutional layers using static or other convolutional layers. As such, the convolutional layer may be preceded by or followed by other types of layers as in prior model architectures, as the convolutional operation may use a dynamic convolutional kernel but otherwise leave the input feature map and output feature map the same as a prior convolutional layer. During training of the computer model and the convolutional layers, the convolutional layer may learn parameters for the static convolutional filters [symbol] ₁- [symbol] _{K}, as well as parameters for the attention model itself, such as parameters for the fully-connected, normalization, and activation layers discussed above.

Object Detection with Dynamic Convolutional Kernels

FIG. 7 provides an example structure of an object detector 710 that may include components using convolutional layers that may use a dynamic convolutional filter, according to various embodiments. FIG. 7 shows an example object detector 710 that receives an image 700 and may generate an output 730 that describes objects detected in the input image 700. Object detectors 710 include various components, such as a backbone 705A, neck 705B, and head 705C that are typically composed of several types of layers, including respective convolutional layers 720A-C. In this example architecture, the backbone 705A extracts core features from the image 700, which may include, for example, features that may be applicable to a variety of image processing tasks, while the neck 705B may generate more complex features that may be used by one or more “head” models for prediction for specific purposes, such as individual types of objects. In various embodiments, the object detector 710 may also be considered a one-stage or two-stage detector. In a one-stage detector, the object classification and respective boundaries of the object may be jointly performed; in a two-stage detector, a first stage (e.g., first portion) of the model may generate a set of candidate bounding boxes (e.g., regions of interest in the image) and a second stage (e.g., second portion) of the model predicts a likely classification based on the specific candidate bounding boxes. As a specific example, the dynamic convolutional filter may be used in object detectors as any (or all) of the convolutional layers 720 in any of the components 705A-C.

### Object Detection—Experimental Results

Experimental results demonstrate the benefits of the dynamic convolutional filter as shown in FIG. 6 and according to Equation 1, and particularly for object detectors with a general and efficient design that may be used in many additional contexts. This dynamic convolutional filter achieves a better tradeoff between accuracy and efficiency than existing convolution designs, as validated by extensive experiments on the large-scale object detection dataset MS-COCO. For example, on mainstream object detectors using both lightweight and large CNN (convolutional neural network) architectures as backbones, the disclosed approach brings a mAP margin of 4.5˜6.3% with negligible extra computational cost on the MS-COCO dataset, see detailed results in Table 1 and visualization comparisons in FIG. 6.

The dynamic convolutional filter was used as a “drop-in” for convolutional layers in prevailing object detectors including “Faster R-CNN” and “Mask R-CNN” using ResNet-50 and MobileNetV2 as backbones with object detection benchmark MSCOCO as a dataset for evaluation. As shown in Table 2 below, the dynamic convolutional filter (termed “OAConv”) brings promising accuracy improvements to various backbone models and leads to significantly smaller increases in the model complexity compared to existing dynamic convolution counterparts.

TABLE 2

| Backbones | Detectors | mAP(%) | #Param. (M) | MAdds (G) |
|---|---|---|---|---|
| ResNet-50 | Faster R-CNN | 37.2 | 43.80 | 207.07 |
| +CondConv (K = 8) | | 38.3 | 119.12 | 207.23 |
| +Our OAConv(K = 1) | | 41.5 | 46.88 | 207.18 |
| +Our OAConv(K = 4) | | 41.7 (↑4.5) | 108.91 | 207.42 |
| MobileNetV2(1.0×) | | 31.3 | 21.13 | 122.58 |
| + CondConv (K = 8) | | 34.5 | 30.02 | 123.01 |
| +Our OAConv(K = 1) | | 36.8 | 22.56 | 123.00 |
| +Our OAConv(K = 4) | | 37.6 (↑6.3) | 29.14 | 123.02 |
| ResNet-50 | Mask R-CNN | 38.0 | 46.45 | 260.14 |
| + CondConv (K = 8) | | 39.2 | 121.77 | 260.30 |
| +Our OAConv(K = 1) | | 42.3 | 49.53 | 260.25 |
| +Our OAConv(K = 4) | | 42.6 (↑4.6) | 111.56 | 260.49 |
| MobileNetV2(1.0×) | | 32.2 | 23.78 | 175.66 |
| + CondCony (K = 8) | | 35.2 | 32.68 | 176.09 |
| +Our OAConv(K = 1) | | 37.6 | 25.22 | 176.08 |
| +Our OAConv(K = 4) | | 38.4 (↑6.2) | 31.80 | 176.10 |

Table 2 shows performance comparison of “OAConv” with different numbers of static convolutional filters (K=1 and K=4), each of which outperformed other state-of-the-art models when used as a backbone for object detection.

FIGS. 8A-B shows a visual comparison of detection results on the MS-COCO dataset from the experiment noted above. FIG. 8A shows the object detection results using baseline detector Faster R-CNN with ResNet-50. FIG. 8B shows the detection results using a detector equipped with “OAConv” as a backbone feature detector as discussed above and with data shown in Table 2. As shown, thanks to the improved feature extraction ability (e.g., the effectiveness of the multi-dimensional attention weights), detectors using the dynamic convolutional filter as a backbone outperforms the baseline detector and locates objects with more accurate bounding boxes.

As a further performance discussion, the number of additional parameters for applying the dynamic convolutional filter does not significantly increase processing. In one embodiment, the additional parameters for the attention model may be denoted as K×cᵢₙ×cᵢₙᵣ+K×cᵢₙᵣ×(cₒᵤₜ+cᵢₙ+S). When using K=4 kernels, squeeze ratio r=16 (i.e., the reduction of channels to the dense input representation) and with taking cᵢₙ=256, cₒᵤₜ=512 and s=3×3=9, the number of extra parameters to a single static convolutional layer introduced is about 5.6% of the original static kernel (cₒᵤₜ×cᵢₙ×S), which is a lightweight design, particularly given the performance improvements shown above in Table 2.

### Example Computer Modeling

FIG. 9 shows example computer model inference and computer model training. Computer model inference refers to the application of a computer model 910 to a set of input data 900 to generate an output or model output 920. The computer model 910 determines the model output 920 based on parameters of the model, also referred to as model parameters. The parameters of the model may be determined based on a training process that finds an optimization of the model parameters, typically using training data and desired outputs of the model for the respective training data as discussed below. The output of the computer model may be referred to as an “inference” because it is a predictive value based on the input data 900 and based on previous example data used in the model training.

The input data 900 and the model output 920 vary according to the particular use case. For example, for computer vision and image analysis, the input data 900 may be an image having a particular resolution, such as 75×75 pixels, or a point cloud describing a volume. In other applications, the input data 900 may include a vector, such as a sparse vector, representing information about an object. For example, in recommendation systems, such a vector may represent user-object interactions, such that the sparse vector indicates individual items positively rated by a user. In addition, the input data 900 may be a processed version of another type of input object, for example representing various features of the input object or representing preprocessing of the input object before input of the object to the computer model 910. As one example, a 1024×1024 resolution image may be processed and subdivided into individual image portions of 64×64, which are the input data 900 processed by the computer model 910. As another example, the input object, such as a sparse vector discussed above, may be processed to determine an embedding or another compact representation of the input object that may be used to represent the object as the input data 900 in the computer model 910. Such additional processing for input objects may themselves be learned representations of data, such that another computer model processes the input objects to generate an output that is used as the input data 900 for the computer model 910. Although not further discussed here, such further computer models may be independently or jointly trained with the computer model 910.

As noted above, the model output 920 may depend on the particular application of the computer model 910, and represent recommendation systems, computer vision systems, classification systems, labeling systems, weather prediction, autonomous control, and any other type of modeling output/prediction.

The computer model 910 includes various model parameters, as noted above, that describe the characteristics and functions that generate the model output 920 from the input data 900. In particular, the model parameters may include a model structure, model weights, and a model execution environment. The model structure may include, for example, the particular type of computer model 910 and its structure and organization. For example, the model structure may designate a neural network, which may be comprised of multiple layers, and the model parameters may describe individual types of layers included in the neural network and the connections between layers (e.g., the output of which layers constitute inputs to which other layers). Such networks may include, for example, feature extraction layers, convolutional layers, pooling/dimensional reduction layers, activation layers, output/predictive layers, and so forth. While in some instances the model structure may be determined by a designer of the computer model, in other examples, the model structure itself may be learned via a training process and may thus form certain “model parameters” of the model.

The model weights may represent the values with which the computer model 910 processes the input data 900 to the model output 920. Each portion or layer of the computer model 910 may have such weights. For example, weights may be used to determine values for processing inputs to determine outputs at a particular portion of a model. Stated another way, for example, model weights may describe how to combine or manipulate values of the input data 900 or thresholds for determining activations as output for a model. As one example, a convolutional layer typically includes a set of convolutional “weights,” that together form a convolutional filter to be applied to a set of inputs to that layer in a convolutional operation. These are subsequently combined, typically along with a “bias” parameter, and weights for other transformations to generate an output for the convolutional layer.

The model execution parameters represent parameters describing the execution conditions for the model. In particular, aspects of the model may be implemented on various types of hardware or circuitry for executing the computer model. For example, portions of the model may be implemented in various types of circuitry, such as general-purpose circuitry (e.g., a general CPU), circuitry specialized for certain computer model functions (e.g., a GPU or programmable Multiply-and-Accumulate circuit) or circuitry specially designed for the particular computer model application. In some configurations, different portions of the computer model 910 may be implemented on different types of circuitry. As discussed below, training of the model may include optimizing the types of hardware used for certain aspects of the computer model (e.g., co-trained), or may be determined after other parameters for the computer model are determined without regard to configuration executing the model. In another example, the execution parameters may also determine or limit the types of processes or functions available at different portions of the model, such as value ranges available at certain points in the processes, operations available for performing a task, and so forth.

Computer model training may thus be used to determine or “train” the values of the model parameters for the computer model 940. During training, the model parameters are optimized to “learn” values of the model parameters (such as individual weights, activation values, model execution environment, etc.), that improve the model parameters based on an optimization function that seeks to improve a cost function (also sometimes termed a loss function). Before training, the computer model 940 has model parameters that have initial values that may be selected in various ways, such as by a randomized initialization, initial values selected based on other or similar computer models, or by other means. During training, the model parameters are modified based on the optimization function to improve the cost/loss function relative to the prior model parameters.

In many applications, training data 930 includes a data set to be used for training the computer model 940. The data set varies according to the particular application and purpose of the computer model 940. In supervised learning tasks, the training data typically includes a set of training data labels that describe the training data and the desired output of the model relative to the training data. For example, for an object classification task, the training data may include individual images in which individual portions, regions or pixels in the image are labeled with the classification of the object. For this task, the training data may include a training data image depicting a dog and a person and a training data labels that label the regions of the image that include the dog and the person, such that the computer model is intended to learn to also label the same portions of that image as a dog and a person, respectively.

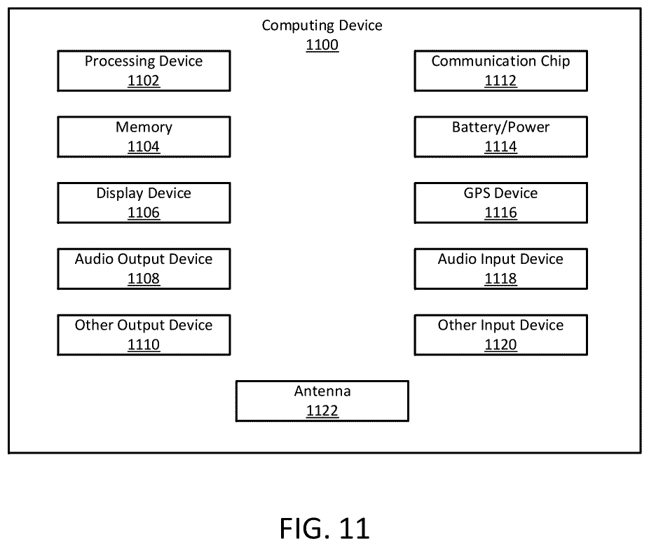

To train the computer model, a training module (not shown) applies the training inputs 930 to the computer model 940 to determine the outputs predicted by the model for the given training inputs 930. The training module, though not shown, is a computing module used for performing the training of the computer model by executing the computer model according to its inputs and outputs given the model's parameters and modifying the model parameters based on the results. The training module may apply the actual execution environment of the computer model 940, or may simulate the results of the execution environment, for example to estimate the performance, runtime, memory, or circuit area (e.g., if specialized hardware is used) of the computer model. The training module, along with the training data and model evaluation, may be instantiated in software and/or hardware by one or more processing devices such as the example computing device 1100 shown in FIG. 11. In various examples, the training process may also be performed by multiple computing systems in conjunction with one another, such as distributed/cloud computing systems.

After processing the training inputs according to the current model parameters for the computer model 940, the model's predicted outputs are evaluated 950 and the computer model is evaluated with respect to the cost function and optimized using an optimization function of the training model. Depending on the optimization function, particular training process and training parameters after the model evaluation are updated to improve the optimization function of the computer model. In supervised training (i.e., training data labels are available), the cost function may evaluate the model's predicted outputs relative to the training data labels and to evaluate the relative cost or loss of the prediction relative to the “known” labels for the data. This provides a measure of the frequency of correct predictions by the computer model and may be measured in various ways, such as the precision (frequency of false positives) and recall (frequency of false negatives). The cost function in some circumstances may evaluate may also evaluate other characteristics of the model, for example the model complexity, processing speed, memory requirements, physical circuit characteristics (e.g., power requirements, circuit throughput) and other characteristics of the computer model structure and execution environment (e.g., to evaluate or modify these model parameters).

After determining results of the cost function, the optimization function determines a modification of the model parameters to improve the cost function for the training data. Many such optimization functions are known to one skilled on the art. Many such approaches differentiate the cost function with respect to the parameters of the model and determine modifications to the model parameters that thus improves the cost function. The parameters for the optimization function, including algorithms for modifying the model parameters are the training parameters for the optimization function. For example, the optimization algorithm may use gradient descent (or its variants), momentum-based optimization, or other optimization approaches used in the art and as appropriate for the particular use of the model. The optimization algorithm thus determines the parameter updates to the model parameters. In some implementations, the training data is batched and the parameter updates are iteratively applied to batches of the training data. For example, the model parameters may be initialized, then applied to a first batch of data to determine a first modification to the model parameters. The second batch of data may then be evaluated with the modified model parameters to determine a second modification to the model parameters, and so forth, until a stopping point, typically based on either the amount of training data available or the incremental improvements in model parameters are below a threshold (e.g., additional training data no longer continues to improve the model parameters). Additional training parameters may describe the batch size for the training data, a portion of training data to use as validation data, the step size of parameter updates, a learning rate of the model, and so forth. Additional techniques may also be used to determine global optimums or address nondifferentiable model parameter spaces.

FIG. 10 illustrates an example neural network architecture. In general, a neural network includes an input layer 1010, one or more hidden layers 1020, and an output layer 1030. The values for data in each layer of the network is generally determined based on one or more prior layers of the network. Each layer of a network generates a set of values, termed “activations” that represent the output values of that layer of a network and may be the input to the next layer of the network. For the input layer 1010, the activations are typically the values of the input data, although the input layer 1010 may represent input data as modified through one or more transformations to generate representations of the input data. For example, in recommendation systems, interactions between users and objects may be represented as a sparse matrix. Individual users or objects may then be represented as an input layer 1010 as a transformation of the data in the sparse matrix relevant to that user or object. The neural network may also receive the output of another computer model (or several), as its input layer 1010, such that the input layer 1010 of the neural network shown in FIG. 10 is the output of another computer model. Accordingly, each layer may receive a set of inputs, also termed “input activations,” representing activations of one or more prior layers of the network and generate a set of outputs, also termed “output activations” representing the activation of that layer of the network. Stated another way, one layer's output activations become the input activations of another layer of the network (except for the final output layer of 1030 of the network.

Each layer of the neural network typically represents its output activations (i.e., also termed its outputs) in a matrix, which may be 1, 2, 3, or n-dimensional according to the particular structure of the network. As shown in FIG. 10, the dimensionality of each layer may differ according to the design of each layer. The dimensionality of the output layer 1030 depend on the characteristics of the prediction made by the model. For example, a computer model for multi-object classification may generate an output layer 1030 having a one-dimensional array in which each position in the array represents the likelihood of a different classification for the input layer 1010. In another example for classification of portions of an image, the input layer 1010 may be an image having a resolution, such as 512×512, and the output layer may be a 512×512×n matrix in which the output layer 1030 provides n classification predictions for each of the input pixels, such that the corresponding position of each pixel in the input layer 1010 in the output layer 1030 is an n-dimensional array corresponding to the classification predictions for that pixel.

The hidden layers 1020 provide output activations that variously characterize the input layer 1010 in various ways that assist in effectively generating the output layer 1030. The hidden layers thus may be considered to provide additional features or characteristics of the input layer 1010. Though two hidden layers are shown in FIG. 10, in practice any number of hidden layers may be provided in various neural network structures.

Each layer generally determines the output activation values of positions in its activation matrix based on the output activations of one or more previous layers of the neural network (which may be considered input activations to the layer being evaluated). Each layer applies a function to the input activations to generate its activations. Such layers may include fully-connected layers (e.g., every input is connected to every output of a layer), convolutional layers, deconvolutional layers, pooling layers, and recurrent layers. Various types of functions may be applied by a layer, including linear combinations, convolutional kernels, activation functions, pooling, and so forth. The parameters of a layer's function are used to determine output activations for a layer from the layer's activation inputs and are typically modified during the model training process. The parameters describing the contribution of a particular portion of a prior layer is typically termed a weight. For example, in some layers, the function is a multiplication of each input with a respective weight to determine the activations for that layer. For a neural network, the parameters for the model as a whole thus may include the parameters for each of the individual layers and in large-scale networks can include hundreds of thousands, millions, or more of different parameters.

As one example for training a neural network, the cost function is evaluated at the output layer 1030. To determine modifications of the parameters for each layer, the parameters of each prior layer may be evaluated to determine respective modifications. In one example, the cost function (or “error”) is backpropagated such that the parameters are evaluated by the optimization algorithm for each layer in sequence, until the input layer 1010 is reached.

### Example Devices

FIG. 11 is a block diagram of an example computing device 1100 that may include one or more components used for applying or training a computer model in accordance with any of the embodiments disclosed herein. For example, the computing device 1100 may include a model inference module or a training module for applying and training various models using the techniques discussed herein.

A number of components are illustrated in FIG. 11 as included in the computing device 1100, but any one or more of these components may be omitted or duplicated, as suitable for the application. In some embodiments, some or all of the components included in the computing device 1100 may be attached to one or more motherboards. In some embodiments, some or all of these components are fabricated onto a single system-on-a-chip (SoC) die.

Additionally, in various embodiments, the computing device 1100 may not include one or more of the components illustrated in FIG. 11, but the computing device 1100 may include interface circuitry for coupling to the one or more components. For example, the computing device 1100 may not include a display device 1106, but may include display device interface circuitry (e.g., a connector and driver circuitry) to which a display device 1106 may be coupled. In another set of examples, the computing device 1100 may not include an audio input device 1118 or an audio output device 1108 but may include audio input or output device interface circuitry (e.g., connectors and supporting circuitry) to which an audio input device 1118 or audio output device 1108 may be coupled.

The computing device 1100 may include a processing device 1102 (e.g., one or more processing devices). As used herein, the term “processing device” or “processor” may refer to any device or portion of a device that processes electronic data from registers and/or memory to transform that electronic data into other electronic data that may be stored in registers and/or memory. The processing device 1102 may include one or more digital signal processors (DSPs), application-specific ICs (ASICs), central processing units (CPUs), graphics processing units (GPUs), cryptoprocessors (specialized processors that execute cryptographic algorithms within hardware), server processors, or any other suitable processing devices. The computing device 1100 may include a memory 1104, which may itself include one or more memory devices such as volatile memory (e.g., dynamic random-access memory (DRAM)), nonvolatile memory (e.g., read-only memory (ROM), flash memory, solid state memory, and/or a hard drive. The memory 1104 may include instructions executable by the processing device for performing methods and functions as discussed herein. Such instructions may be instantiated in various types of memory, which may include non-volatile memory and as stored on one or more non-transitory mediums. In some embodiments, the memory 1104 may include memory that shares a die with the processing device 1102. This memory may be used as cache memory and may include embedded dynamic random-access memory (eDRAM) or spin transfer torque magnetic random-access memory (STT-MRAM).

In some embodiments, the computing device 1100 may include a communication chip 1112 (e.g., one or more communication chips). For example, the communication chip 1112 may be configured for managing wireless communications for the transfer of data to and from the computing device 1100. The term “wireless” and its derivatives may be used to describe circuits, devices, systems, methods, techniques, communications channels, etc., that may communicate data through the use of modulated electromagnetic radiation through a nonsolid medium. The term does not imply that the associated devices do not contain any wires, although in some embodiments they might not.

The communication chip 1112 may implement any of a number of wireless standards or protocols, including but not limited to Institute for Electrical and Electronic Engineers (IEEE) standards including Wi-Fi (IEEE 802.11 family), IEEE 802.16 standards (e.g., IEEE 802.16-2005 Amendment), Long-Term Evolution (LTE) project along with any amendments, updates, and/or revisions (e.g., advanced LTE project, ultramobile broadband (UMB) project (also referred to as “3GPP2”), etc.). IEEE 802.16 compatible Broadband Wireless Access (BWA) networks are generally referred to as WiMAX networks, an acronym that stands for Worldwide Interoperability for Microwave Access, which is a certification mark for products that pass conformity and interoperability tests for the IEEE 802.16 standards. The communication chip 1112 may operate in accordance with a Global System for Mobile Communication (GSM), General Packet Radio Service (GPRS), Universal Mobile Telecommunications System (UMTS), High-Speed Packet Access (HSPA), Evolved HSPA (E-HSPA), or LTE network. The communication chip 1112 may operate in accordance with Enhanced Data for GSM Evolution (EDGE), GSM EDGE Radio Access Network (GERAN), Universal Terrestrial Radio Access Network (UTRAN), or Evolved UTRAN (E-UTRAN). The communication chip 1112 may operate in accordance with Code Division Multiple Access (CDMA), Time Division Multiple Access (TDMA), Digital Enhanced Cordless Telecommunications (DECT), Evolution-Data Optimized (EV-DO), and derivatives thereof, as well as any other wireless protocols that are designated as 3G, 4G, 5G, and beyond. The communication chip 1112 may operate in accordance with other wireless protocols in other embodiments. The computing device 1100 may include an antenna 1122 to facilitate wireless communications and/or to receive other wireless communications (such as AM or FM radio transmissions).

In some embodiments, the communication chip 1112 may manage wired communications, such as electrical, optical, or any other suitable communication protocols (e.g., the Ethernet). As noted above, the communication chip 1112 may include multiple communication chips. For instance, a first communication chip 1112 may be dedicated to shorter-range wireless communications such as Wi-Fi or Bluetooth, and a second communication chip 1112 may be dedicated to longer-range wireless communications such as global positioning system (GPS), EDGE, GPRS, CDMA, WiMAX, LTE, EV-DO, or others. In some embodiments, a first communication chip 1112 may be dedicated to wireless communications, and a second communication chip 1112 may be dedicated to wired communications.

The computing device 1100 may include battery/power circuitry 1114. The battery/power circuitry 1114 may include one or more energy storage devices (e.g., batteries or capacitors) and/or circuitry for coupling components of the computing device 1100 to an energy source separate from the computing device 1100 (e.g., AC line power).

The computing device 1100 may include a display device 1106 (or corresponding interface circuitry, as discussed above). The display device 1106 may include any visual indicators, such as a heads-up display, a computer monitor, a projector, a touchscreen display, a liquid crystal display (LCD), a light-emitting diode display, or a flat panel display, for example.

The computing device 1100 may include an audio output device 1108 (or corresponding interface circuitry, as discussed above). The audio output device 1108 may include any device that generates an audible indicator, such as speakers, headsets, or earbuds, for example.

The computing device 1100 may include an audio input device 1118 (or corresponding interface circuitry, as discussed above). The audio input device 1118 may include any device that generates a signal representative of a sound, such as microphones, microphone arrays, or digital instruments (e.g., instruments having a musical instrument digital interface (MIDI) output).

The computing device 1100 may include a GPS Device 1116 (or corresponding interface circuitry, as discussed above). The GPS Device 1116 may be in communication with a satellite-based system and may receive a location of the computing device 1100, as known in the art.

The computing device 1100 may include an other output device 1110 (or corresponding interface circuitry, as discussed above). Examples of the other output device 1110 may include an audio codec, a video codec, a printer, a wired or wireless transmitter for providing information to other devices, or an additional storage device.

The computing device 1100 may include an other input device 1120 (or corresponding interface circuitry, as discussed above). Examples of the other input device 1120 may include an accelerometer, a gyroscope, a compass, an image capture device, a keyboard, a cursor control device such as a mouse, a stylus, a touchpad, a bar code reader, a Quick Response (QR) code reader, any sensor, or a radio frequency identification (RFID) reader.

The computing device 1100 may have any desired form factor, such as a hand-held or mobile computing device (e.g., a cell phone, a smart phone, a mobile internet device, a music player, a tablet computer, a laptop computer, a netbook computer, an ultrabook computer, a personal digital assistant (PDA), an ultramobile personal computer, etc.), a desktop computing device, a server or other networked computing component, a printer, a scanner, a monitor, a set-top box, an entertainment control unit, a vehicle control unit, a digital camera, a digital video recorder, or a wearable computing device. In some embodiments, the computing device 1100 may be any other electronic device that processes data.

### SELECT EXAMPLES

The following paragraphs provide various examples of the embodiments disclosed herein.

Example 1 provides a method, including: receiving an input feature map for a convolutional layer of a neural network implementing a dynamic convolutional kernel; determining a plurality of attention weight sets based on the input feature map, the plurality of attention weight sets including spatial attention weights describing weights for a plurality of spatial positions, input channel attention weights describing attention weights for a plurality of input channels, and output channel attention weights describing attention weights for a plurality of output channels; determining a set of convolutional weights for the dynamic convolutional kernel, each convolutional weight of the set of convolutional weights determined by applying respective spatial attention weights in the spatial attention weight set, input channel attention weights in the input channel attention weight set, and output channel attention weights in the output channel weight set; and applying the set of convolutional weights to the input feature map to generate an output feature map

Example 2 provides for the method of example 1, wherein the plurality of attention weight sets are determined by the input feature map applied to an attention computer model.

Example 3 provides for the method of example 2, wherein the attention computer model pools values of the input feature map within each channel of the input feature map.

Example 4 provides for the method of example 3, wherein after pooling values, the attention computer model reduces the number of channels of the input feature map.

Example 5 provides for the method of example 2, wherein the attention computer model generates each attention weight set with one or more parallel neural network layers.

Example 6 provides for the method of any of examples 1-5, wherein the plurality of attention weight sets includes a kernel attention weight set for a plurality of convolutional kernels and the set of convolutional weights is further based on the kernel attention weight set applied to the plurality of convolutional kernels.

Example 7 provides for the method of example 2, wherein the plurality of attention weight sets are determined by a computer model and parameters of the computer model are jointly trained with the plurality of convolutional kernels.

Example 8 provides for the method of any of examples 1-7, wherein the set of convolutional weights for the dynamic convolutional kernel includes a plurality of output channel filters and each output channel filter is determined based on respective spatial attention weights, input channel weights, and output channel weights in the plurality of attention weight sets.

Example 9 provides for a system including a processor; and a non-transitory computer-readable storage medium containing computer program code for execution by the processor for: receiving an input feature map for a convolutional layer of a neural network implementing a dynamic convolutional kernel; determining a plurality of attention weight sets based on the input feature map, the plurality of attention weight sets including spatial attention weights describing weights for a plurality of spatial positions, input channel attention weights describing attention weights for a plurality of input channels, and output channel attention weights describing attention weights for a plurality of output channels; determining a set of convolutional weights for the dynamic convolutional kernel, each convolutional weight of the set of convolutional weights determined by applying respective spatial attention weights in the spatial attention weight set, input channel attention weights in the input channel attention weight set, and output channel attention weights in the output channel weight set; and applying the set of convolutional weights to the input feature map to generate an output feature map

Example 10 provides for the system of example 9, wherein the plurality of attention weight sets are determined by the input feature map applied to an attention computer model.

Example 11 provides for the system of example 10, wherein the attention computer model pools values of the input feature map within each channel of the input feature map.

Example 12 provides for the system of example 11, wherein after pooling values, the attention computer model reduces the number of channels of the input feature map.

Example 13 provides for the system of example 10, wherein the attention computer model generates each attention weight set with one or more parallel neural network layers.

Example 14 provides for the system of any of examples 9-13, wherein the plurality of attention weight sets includes a kernel attention weight set for a plurality of convolutional kernels and the set of convolutional weights is further based on the kernel attention weight set applied to the plurality of convolutional kernels.

Example 15 provides for the system of example 10, wherein the plurality of attention weight sets are determined by a computer model and parameters of the computer model are jointly trained with the plurality of convolutional kernels.

Example 16 provides for the system of any of examples 9-15, wherein the set of convolutional weights for the dynamic convolutional kernel includes a plurality of output channel filters and each output channel filter is determined based on respective spatial attention weights, input channel weights, and output channel weights in the plurality of attention weight sets.

Example 17 provides for a non-transitory computer-readable storage medium containing instructions executable by a processor for: receiving an input feature map for a convolutional layer of a neural network implementing a dynamic convolutional kernel; determining a plurality of attention weight sets based on the input feature map, the plurality of attention weight sets including spatial attention weights describing weights for a plurality of spatial positions, input channel attention weights describing attention weights for a plurality of input channels, and output channel attention weights describing attention weights for a plurality of output channels; determining a set of convolutional weights for the dynamic convolutional kernel, each convolutional weight of the set of convolutional weights determined by applying respective spatial attention weights in the spatial attention weight set, input channel attention weights in the input channel attention weight set, and output channel attention weights in the output channel weight set; and applying the set of convolutional weights to the input feature map to generate an output feature map

Example 18 provides for the non-transitory computer-readable storage medium of example 17, wherein the plurality of attention weight sets are determined by the input feature map applied to an attention computer model.

Example 19 provides for the non-transitory computer-readable storage medium of example 18, wherein the attention computer model pools values of the input feature map within each channel of the input feature map.

Example 20 provides for the non-transitory computer-readable storage medium of example 19, wherein after pooling values, the attention computer model reduces the number of channels of the input feature map.

Example 21 provides for the non-transitory computer-readable storage medium of example 18, wherein the attention computer model generates each attention weight set with one or more parallel neural network layers.

Example 22 provides for the non-transitory computer-readable storage medium of any of examples 17-21, wherein the plurality of attention weight sets includes a kernel attention weight set for a plurality of convolutional kernels and the set of convolutional weights is further based on the kernel attention weight set applied to the plurality of convolutional kernels.

Example 23 provides for the non-transitory computer-readable storage medium of example 18, wherein the plurality of attention weight sets are determined by a computer model and parameters of the computer model are jointly trained with the plurality of convolutional kernels.

Example 24 provides for the non-transitory computer-readable storage medium of any of examples 17-23, wherein the set of convolutional weights for the dynamic convolutional kernel includes a plurality of output channel filters and each output channel filter is determined based on respective spatial attention weights, input channel weights, and output channel weights in the plurality of attention weight sets.

The above description of illustrated implementations of the disclosure, including what is described in the Abstract, is not intended to be exhaustive or to limit the disclosure to the precise forms disclosed. While specific implementations of, and examples for, the disclosure are described herein for illustrative purposes, various equivalent modifications are possible within the scope of the disclosure, as those skilled in the relevant art will recognize. These modifications may be made to the disclosure in light of the above detailed description.

1. A method comprising:
receiving an input feature map for a convolutional layer of a neural network implementing a dynamic convolutional kernel;
determining a plurality of attention weight sets based on the input feature map, the plurality of attention weight sets including spatial attention weights describing weights for a plurality of spatial positions, input channel attention weights describing attention weights for a plurality of input channels, and output channel attention weights describing attention weights for a plurality of output channels;
determining a set of convolutional weights for the dynamic convolutional kernel, each convolutional weight of the set of convolutional weights determined by applying respective spatial attention weights in the spatial attention weight set, input channel attention weights in the input channel attention weight set, and output channel attention weights in the output channel weight set; and
applying the set of convolutional weights to the input feature map to generate an output feature map.

2. The method of claim 1, wherein the plurality of attention weight sets are determined by the input feature map applied to an attention computer model.

3. The method of claim 2, wherein the attention computer model pools values of the input feature map within each channel of the input feature map.

4. The method of claim 3, wherein after pooling values, the attention computer model reduces the number of channels of the input feature map.

5. The method of claim 2, wherein the attention computer model generates each attention weight set with one or more parallel neural network layers.

6. The method of claim 1, wherein the plurality of attention weight sets includes a kernel attention weight set for a plurality of convolutional kernels and the set of convolutional weights is further based on the kernel attention weight set applied to the plurality of convolutional kernels.

7. The method of claim 2, wherein the plurality of attention weight sets are determined by a computer model and parameters of the computer model are jointly trained with the plurality of convolutional kernels.

8. The method of claim 1, wherein the set of convolutional weights for the dynamic convolutional kernel includes a plurality of output channel filters and each output channel filter is determined based on respective spatial attention weights, input channel weights, and output channel weights in the plurality of attention weight sets.

9. A system comprising:
a processor; and
a non-transitory computer-readable storage medium containing computer program code for execution by the processor for:
receiving an input feature map for a convolutional layer of a neural network implementing a dynamic convolutional kernel,
determining a plurality of attention weight sets based on the input feature map, the plurality of attention weight sets including spatial attention weights describing weights for a plurality of spatial positions, input channel attention weights describing attention weights for a plurality of input channels, and output channel attention weights describing attention weights for a plurality of output channels,
determining a set of convolutional weights for the dynamic convolutional kernel, each convolutional weight of the set of convolutional weights determined by applying respective spatial attention weights in the spatial attention weight set, input channel attention weights in the input channel attention weight set, and output channel attention weights in the output channel weight set, and
applying the set of convolutional weights to the input feature map to generate an output feature map.

10. The system of claim 9, wherein the plurality of attention weight sets are determined by the input feature map applied to an attention computer model.

11. The system of claim 10, wherein the attention computer model pools values of the input feature map within each channel of the input feature map.

12. The system of claim 11, wherein after pooling values, the attention computer model reduces the number of channels of the input feature map.

13. The system of claim 10, wherein the attention computer model generates each attention weight set with one or more parallel neural network layers.

14. The system of claim 9, wherein the plurality of attention weight sets includes a kernel attention weight set for a plurality of convolutional kernels and the set of convolutional weights is further based on the kernel attention weight set applied to the plurality of convolutional kernels.

15. The system of claim 10, wherein the plurality of attention weight sets are determined by a computer model and parameters of the computer model are jointly trained with the plurality of convolutional kernels.

16. The system of claim 9, wherein the set of convolutional weights for the dynamic convolutional kernel includes a plurality of output channel filters and each output channel filter is determined based on respective spatial attention weights, input channel weights, and output channel weights in the plurality of attention weight sets.

17. A non-transitory computer-readable storage medium containing instructions executable by a processor for:
receiving an input feature map for a convolutional layer of a neural network implementing a dynamic convolutional kernel;
determining a plurality of attention weight sets based on the input feature map, the plurality of attention weight sets including spatial attention weights describing weights for a plurality of spatial positions, input channel attention weights describing attention weights for a plurality of input channels, and output channel attention weights describing attention weights for a plurality of output channels;
determining a set of convolutional weights for the dynamic convolutional kernel, each convolutional weight of the set of convolutional weights determined by applying respective spatial attention weights in the spatial attention weight set, input channel attention weights in the input channel attention weight set, and output channel attention weights in the output channel weight set; and
applying the set of convolutional weights to the input feature map to generate an output feature map.

18. The non-transitory computer readable medium of claim 17, wherein the plurality of attention weight sets are determined by the input feature map applied to an attention computer model, wherein the attention computer model pools values of the input feature map within each channel of the input feature map or generates each attention weight set with one or more parallel neural network layers.

19-21. (canceled)

22. The non-transitory computer readable medium of claim 17, wherein the plurality of attention weight sets includes a kernel attention weight set for a plurality of convolutional kernels and the set of convolutional weights is further based on the kernel attention weight set applied to the plurality of convolutional kernels.

23. (canceled)

24. The non-transitory computer readable medium of claim 17, wherein the set of convolutional weights for the dynamic convolutional kernel includes a plurality of output channel filters and each output channel filter is determined based on respective spatial attention weights, input channel weights, and output channel weights in the plurality of attention weight sets.
